(19) United States
(12) Patent Application Publication
(10) Pub. No.: US 2005/0023469 A1
(43) Pub. Date: Feb. 3, 2005

(54) Digital video thermal electric controller loop utilizing video reference pixels on focal plane arrays

(76) Inventors: Richard Chin, Torrance, CA (US); Frank Nam Go Cheung, Agoura Hills, CA (US); Eric B. Sutton, Los Angeles, CA (US)

Correspondence Address: PATENT DOCKET ADMINISTRATION;RAYTHEON SYSTEMS COMPANY, P.O. BOX 902 (E1/E150), BLDG E1 M S E150, EL SEGUNDO, CA, 90245-0902, US

(21) Appl. No.: 10/629,042

(22) Filed: Jul. 28, 2003

(51) Int. Cl. G01J 5/02

(52) U.S. Cl. 250/352

(57) ABSTRACT

A system and method for stabilizing the temperature of a detector array. The novel invention (100) includes one or more video reference pixels (52) adapted to output a reference signal that is responsive to the temperature of the detector array (50), and a mechanism for adjusting the temperature of the detector array (50) based on the reference signal. In the illustrative embodiment, the mechanism includes a thermal electric cooler (112) and a processor (104) running a control algorithm (106) which calculates the amount of current which should be applied to the thermal electric cooler (112) based on the reference signal from the video reference pixels (52). The video reference pixels (52) are constructed from the same substrate as the detector array (50), but are constructed in a manner such that they do not respond to changes in scene illumination.

### BACKGROUND OF THE INVENTION

1. Field of the Invention

The present invention relates to sensors. More specifically, the present invention relates to thermal stabilization of infrared detectors.

2. Description of the Related Art

Detectors for infrared imaging systems are highly sensitive to thermal variations in substrate body temperature. Slight temperature variations can cause the noise in the detectors to overpower the detected signal.

A technique for minimizing the effect of substrate temperature variations is to provide “cooling” of the substrate (i.e., substrate temperature stabilization) so as to maintain a substantially constant substrate temperature. One common technique employed for substrate temperature stabilization is the use of what is commonly referred to as “thermoelectric cooling”. As used herein, the term “thermal electric cooler” is equivalent to the term “thermal electric stabilizer”—both of which are commonly used in the art and refer to a technique for raising and lowering the temperature of a substrate to maintain the substrate at a substantially constant temperature.

Thermal electric cooling is typically controlled by an analog control loop based on a thermistor with analog feedback. These thermal electric control loops need large amounts of circuit board space and additional power to drive the analog components. The more sophisticated the control loop, the more space is required. Furthermore, analog circuits are fixed. Once a control algorithm is implemented in analog circuitry, it cannot be changed. Another shortcoming of prior art thermal electric controllers comes from the thermistor which is used to sense the temperature of the detector substrate. Since it is simply bonded onto the focal plane array, the thermistor has a small thermal lag and does not give an instantaneous accurate measurement.

Prior attempts at a digital control loop digitized the output of the thermistor for digital processing. These digital circuits are more flexible than analog systems, but still have the thermal lag problem associated with the thermistor. In addition, they require an extra analog to digital converter. Hybrid systems have also been designed which maintain some analog components. These systems also have the thermal lag problem, as well as requiring extra power and circuit board space.

Hence, a need exists in the art for an improved system or method for stabilizing the temperature of detector arrays which offers greater flexibility and more accuracy, and requires less space and power than prior art methods.

### SUMMARY OF THE INVENTION

The need in the art is addressed by the system and method for stabilizing the temperature of a detector array of the present invention. The novel invention includes one or more video reference pixels adapted to output a reference signal that is responsive to the temperature of the detector array, and a mechanism for adjusting the temperature of the detector array based on the reference signal. In the illustrative embodiment, the mechanism includes a thermal electric cooler and a processor running a control algorithm which calculates the amount of current which should be applied to the thermal electric cooler based on the reference signal from the video reference pixels. The video reference pixels are constructed from the same substrate as the detector array, but are constructed in a manner such that they do not respond to changes in scene illumination.

### BRIEF DESCRIPTION OF THE DRAWINGS

FIG. 1 is a schematic of a thermal electric cooler control circuit of conventional design and construction.

FIG. 2 is an illustration showing a detector assembly with video reference pixels designed in accordance with an illustrative embodiment of the present invention.

FIG. 3 is a schematic of a thermal electric cooler control circuit designed in accordance with an illustrative embodiment of the present invention.

FIG. 4 is a flow chart of a digital control loop algorithm designed in accordance with an illustrative embodiment of the present invention.

FIG. 5 is a block diagram of a digital control loop with multiple types of controllers designed in accordance with an illustrative embodiment of the present invention.

FIG. 6a is a graph showing the simulated response of a first type of controller.

FIG. 6b is a graph showing the simulated response of a second type of controller.

FIG. 6c is a graph showing the simulated response of an algorithm that switches from the first type of controller to the second.

### DESCRIPTION OF THE INVENTION

Illustrative embodiments and exemplary applications will now be described with reference to the accompanying drawings to disclose the advantageous teachings of the present invention.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

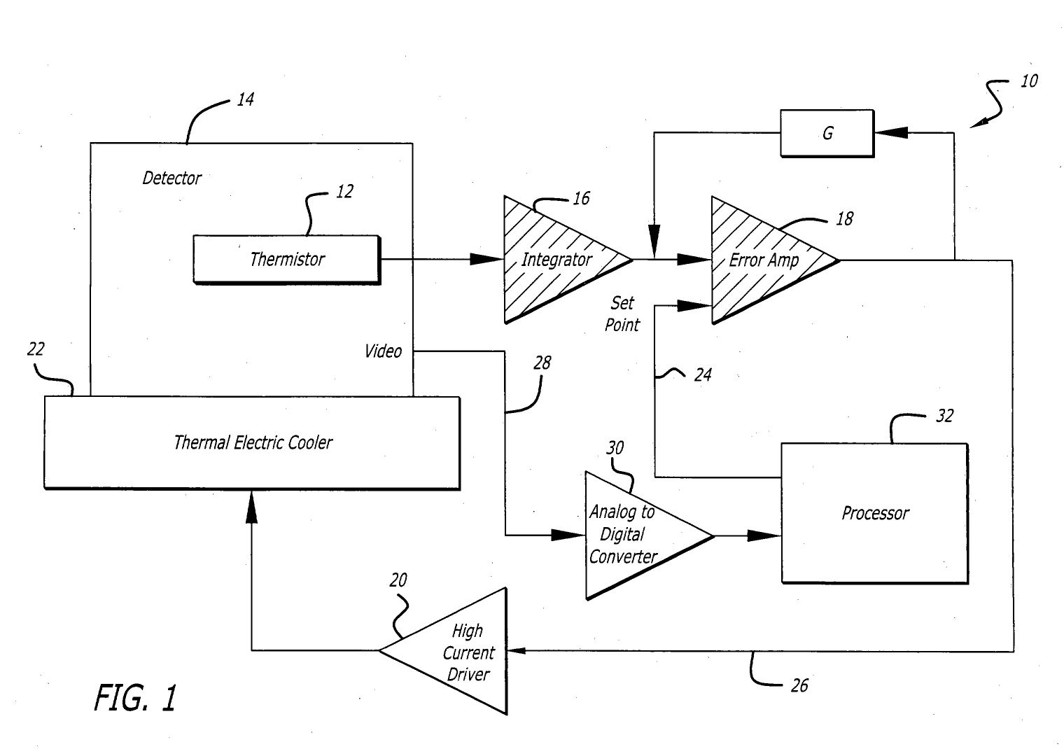

FIG. 1 is a schematic of a thermal electric cooler control circuit 10 of conventional design and construction. The circuit or “control loop” 10 includes a thermistor 12 mounted on a detector array 14, an integrator 16, an error amplifier 18, a high current driver 20, and a thermal electric cooler (TEC) 22. The thermistor 12 senses the temperature of the detector assembly 14. The output of the thermistor 12 is integrated by the integrator 16 and then input to the error amplifier 18. The error amplifier 18 is a differential amplifier having a feedback loop with a gain G. The error amplifier 18 and integrator 14 set compares the output of the thermistor 12 to a desired set-point 24 and outputs a control signal 26 to the current driver 20. The current driver 20 applies a current to the thermal electric cooler 22 in response to the control signal 26. The thermal electric cooler 22 is adapted to heat or cool the detector substrate 14 according to the current or voltage applied to the TEC 22. The control circuit 10 changes the current in the driver 20 until the detector assembly 14 is at the desired temperature.

Also shown in FIG. 1 is the video data stream 28 output from the detector array 14 which is digitized by an analog to digital converter 30 and processed by a processor 32. The processor 32 may also provide the set-point signal 24 for the error amplifier 18.

As discussed above, the thermistor inherently has a thermal lag and does not give an instantaneous accurate measurement. Furthermore, in this type of design there is the additional cost of the integrator and error amplifier circuits, the additional power required for them, plus the type of control loop is fixed.

The thermal electric cooler control circuit of the present invention utilizes one or more “video reference pixels” (VRPs) to sense the temperature of the detector array instead of using a thermistor as with the prior art. The VRPs are pixels that are fabricated from the same material as the rest of the detector, but are either shielded or isolated from the input energy coming from the scene of interest. Both the active area of the detector (the normal imaging pixels) and the VRPs respond to the body temperature of the substrate. The normal imaging pixels respond to the substrate temperature in addition to the scene illumination, while the VRPs respond only to the substrate temperature. The signals from the VRPs can therefore be used as a measurement of the temperature of the detector substrate.

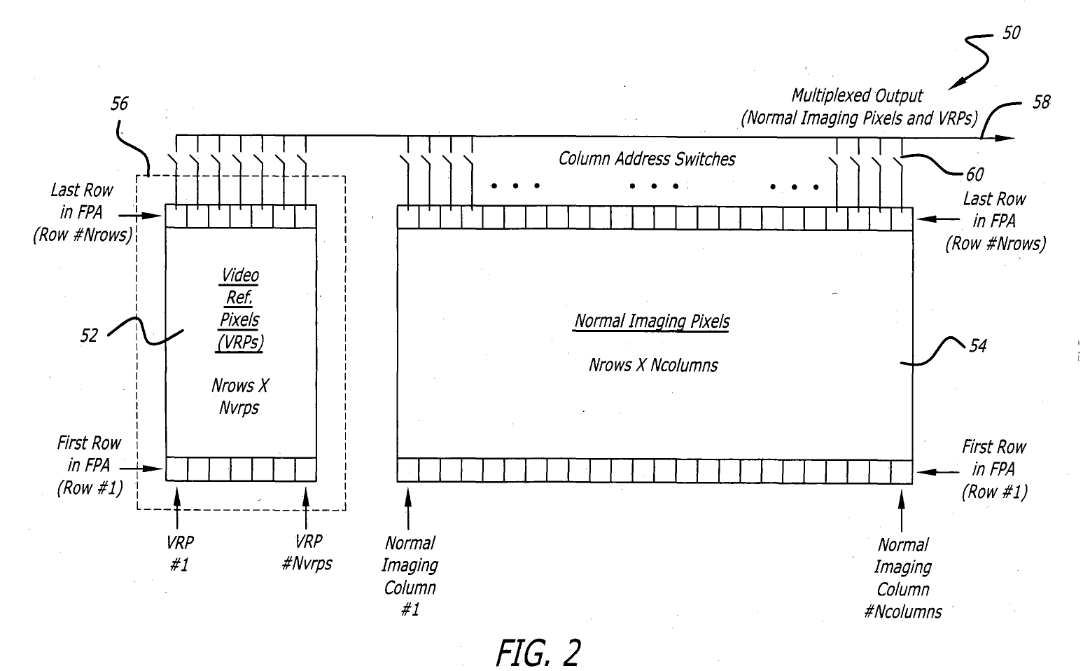

FIG. 2 is an illustration showing a detector assembly 50 with video reference pixels 52 designed in accordance with an illustrative embodiment of the present invention. The detector assembly 50 includes a focal plane array (FPA) of normal imaging detectors 54 (shown is an array of size Nrows×Ncolumns) adapted to receive energy from a scene of interest. Near the normal imaging pixels 54 are a plurality of video reference pixels 52 (shown is an array of size Nrows×Nvrps). In the illustrative example, several VRPs 52 are associated with each row of the FPA. The VRPs 52 are constructed in a manner such that they do not respond to changes in scene illumination. This can be accomplished by shielding them from the scene, or by building them as bolometers that are in intimate thermal contact with the substrate (“heat-sunk” bolometers). In the embodiment of FIG. 2, a radiation shield 56 is used to block the scene illumination from reaching the VRPs 52. Other methods for blocking the scene illumination from the VRPs may be used without departing from the scope of the present teachings. The VRPs, for instance, may be thermally sunk to the substrate, in which case a radiation shield would not be necessary. The VRPs 52 are biased and acquire signals simultaneously with the normal imaging pixels 54. The VRP signals are multiplexed into a video data stream 58 from the FPA, along with the normal imaging pixel signals. Address switches 60 can be used to direct signals from each column of the normal imaging pixels 54 and the VRPs 52 to the multiplexed output 58.

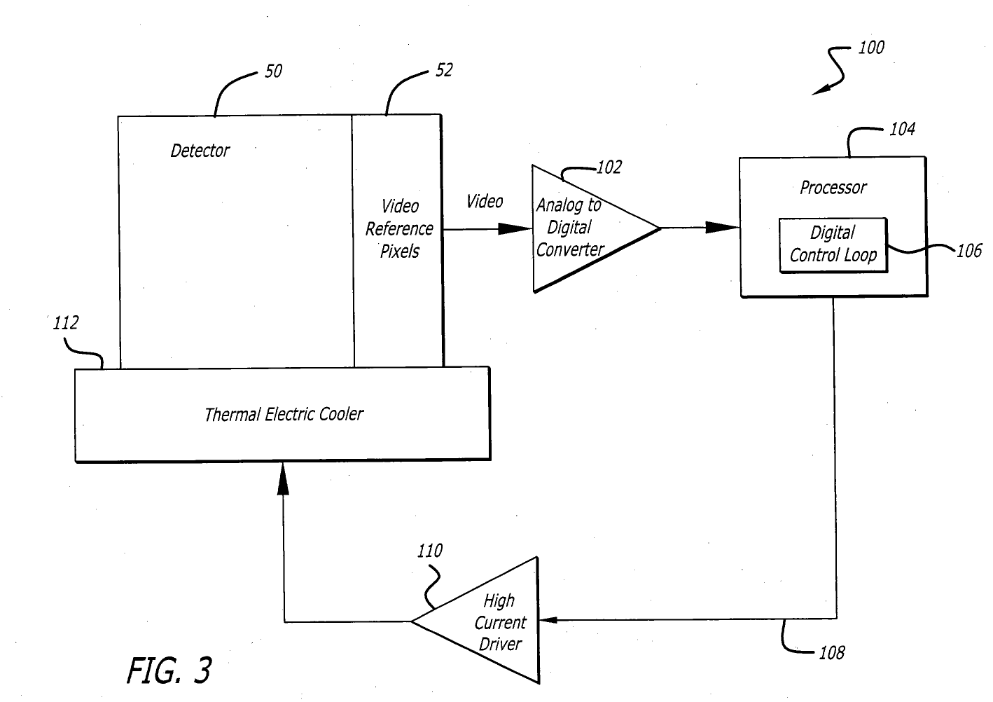

FIG. 3 is a schematic of a thermal electric cooler control circuit 100 designed in accordance with an illustrative embodiment of the present invention. The circuit 100 includes a detector assembly 50 with one or more video reference pixels 52. The signals from the VRPs 52 are digitized by an analog to digital converter 102 and input to a processor 104. In one embodiment of the invention, the signals from the VRPs 52 are multiplexed into a video data stream along with the normal imaging pixel signals. In this embodiment, only one analog to digital converter 102 is required to digitize the output from both the imaging pixels and the VRPs. The processor 104 is running a digital control loop algorithm 106 that outputs a control signal 108 in response to the signals from the VRPs 52. The control signal 108 adjusts the current in a high current driver 110 that drives a thermal electric cooler 112 to heat or cool the detector assembly 50.

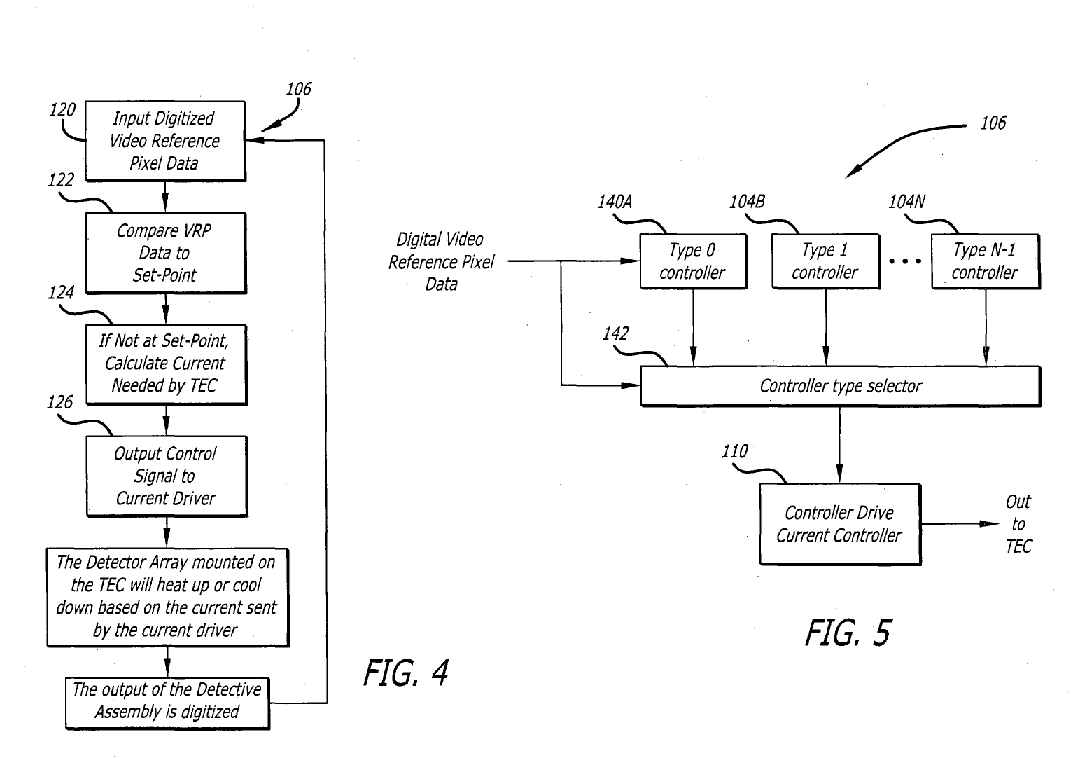

The digital control loop algorithm 106 is designed to maintain the VRPs at a desired temperature. FIG. 4 is a flow chart of a digital control loop algorithm 106 designed in accordance with an illustrative embodiment of the present invention. At Step 120, input the digitized signals from the VRPs 52. At Step 122, compare the VRP data to a predetermined set-point. The set-point corresponds to the response of the VRPs when the detector substrate is at the desired temperature. If the VRPs 52 are at the desired temperature, then no change is required. At Step 124, if the VRP signals indicate that the detectors are not at the desired temperature, then calculate how much current should be sent to the TEC to heat up or cool down the detector assembly. At Step 126, output a control signal to the current driver 110 indicating how much current to apply to the TEC 112. The detector array mounted on the TEC 112 heats up or cools down based on the current sent by the current driver 110 (Step 128), and the output from the detector assembly is digitized (Step 130). The algorithm 106 then returns to Step 120, inputting the digitized signals from the VRPs 52.

By using a digital control loop, more sophisticated algorithms can be implemented without increasing space, power, or cost (as would be needed for analog circuits). Another advantage is the ability to have multiple variations of control algorithms, and the ability to switch instantaneously between the different types of controllers.

A multi-controller type TEC loop can be easily implemented using digital logic FIG. 5 is a block diagram of a digital control loop 106 with multiple types of controllers designed in accordance with an illustrative embodiment of the present invention. The loop includes N types of controllers (140A, 140B, 140N), labeled Type 0, Type 1, to Type N−1. Each controller has different characteristics. The digitized VRP data is input to the controllers and to a selector 142. The selector 142 chooses which controller to use based on the VRP data and how close they are to a stable temperature. The control signal from that controller is then output to the current driver 110.

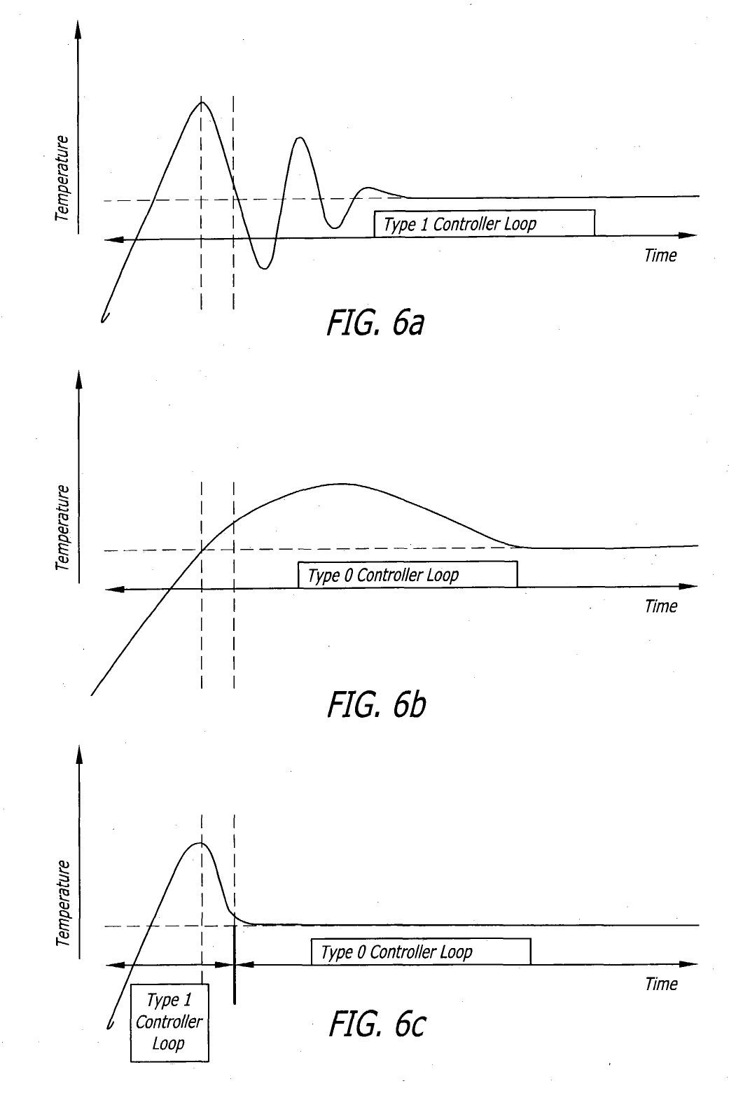

FIGS. 6a-6c are graphs showing the simulated response of three types of control algorithms. As shown in FIG. 6a, the first algorithm (labeled Type 1) reaches the desired temperature relatively quickly, but has some unstability or “ringing”. The second algorithm (Type 0), shown in FIG. 6b, is more stable, but takes much longer to reach the desired temperature. The third algorithm, shown in FIG. 6c, is a combination of the first and second algorithms. The algorithm begins with the Type 1 controller, and then switches to the Type 0 controller when the temperature reaches a settling point. The resulting algorithm reaches the final stabilization point much faster than either single type controller, and is stable.

The ability to switch instantaneously between different types of controllers allows greater flexibility and better performance than can be achieved with single type controllers. This feature would not be possible using analog components.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

Accordingly,

1. A system for stabilizing the temperature of a detector array comprising:
one or more video reference pixels adapted to output a reference signal which is responsive to the temperature of said detector array and
means for adjusting the temperature of said detector array based on said reference signal.

2. The invention of claim 1 wherein said video reference pixels are constructed on the same substrate as said detector array.

3. The invention of claim 1 wherein said video reference pixels are constructed in a manner such that they do not respond to changes in scene illumination.

4. The invention of claim 3 wherein said video reference pixels are shielded from receiving scene illumination.

5. The invention of claim 3 wherein said video reference pixels are thermally sunk to the substrate.

6. The invention of claim 1 wherein said means for adjusting temperature includes a thermal electric cooler adapted to adjust the temperature of said detector array based on a current or voltage applied to the thermal electric cooler.

7. The invention of claim 6 wherein said means for adjusting temperature further includes a current driver adapted to apply a current to said thermal electric cooler in response to a control signal.

8. The invention of claim 7 wherein said means for adjusting temperature further includes a processor running a control algorithm which outputs a control signal to said current driver in response to said reference signal.

9. The invention of claim 8 wherein said means for adjusting temperature further includes an analog to digital converter which digitizes the output of said reference pixels for input to said processor.

10. The invention of claim 8 wherein said algorithm calculates the amount of current which should be sent to the thermal electric cooler in order to maintain the detector array at a desired temperature.

11. The invention of claim 8 wherein said control algorithm compares the reference signal to a predetermined set-point and generates a control signal based on said comparison.

12. The invention of claim 8 wherein said algorithm includes multiple types of controllers.

13. The invention of claim 12 wherein said algorithm further includes a selector that chooses which controller to use based on said reference signal and how close it is to a predetermined set-point.

14. The invention of claim 1 wherein said reference signal is multiplexed with signals from the detector array.

15. A system for stabilizing the temperature of a detector array comprising:
one or more video reference pixels adapted to output a reference signal that is responsive to the temperature of said detector array;
analog to digital converter that digitizes the output of said reference pixels;
a processor running a control algorithm which outputs a control signal in response to said digitized reference signal;
a thermal electric cooler adapted to adjust the temperature of said detector array based on a current or voltage applied to the thermal electric cooler; and
a current driver adapted to apply a current to said thermal electric cooler in response to said control signal.

16. The invention of claim 15 wherein said video reference pixels are constructed from the same substrate as said detector array.

17. The invention of claim 15 wherein said video reference pixels are constructed in a manner such that they do not respond to changes in scene illumination.

18. The invention of claim 17 wherein said video reference pixels are shielded from receiving scene illumination.

19. The invention of claim 17 wherein said video reference pixels are thermally sunk to the substrate.

20. The invention of claim 15 wherein said control algorithm calculates the amount of current which should be sent to the thermal electric cooler in order to maintain the detector array at a desired temperature.

21. The invention of claim 15 wherein said control algorithm compares the reference signal to a predetermined set-point and generates a control signal based on said comparison.

22. The invention of claim 15 wherein said algorithm includes multiple types of controllers.

23. The invention of claim 22 wherein said algorithm further includes a selector that chooses which controller to use based on said reference signal and how close it is to a predetermined set-point.

24. The invention of claim 15 wherein said reference signal is multiplexed with signals from the detector array.

25. A method for stabilizing the temperature of a detector array including the steps of:
obtaining a reference signal indicative of the temperature of said detector array using one or more video reference pixels;
calculating the amount of current which should be sent to a thermal electric cooler in order to maintain the detector array at a desired temperature based on said reference signal; and
sending the calculated amount of current to a thermal electric cooler adapted to adjust the temperature of said detector array.
